(19) United States
(12) Patent Application Publication
(10) Pub. No.: US 2023/0400107 A1
(43) Pub. Date: Dec. 14, 2023

(54) Pneumatic sanding machine with automatic start-up of a dust extractor

(71) Applicant: GYS, SAINT-BERTHEVIN (FR)

(72) Inventor: Bruno Bouygues, Paris (FR)

(21) Appl. No.: 18/333,629

(22) Filed: Jun. 13, 2023

(30) Foreign Application Priority Data
Jun. 14, 2022 (FR) 2205738

(51) Int. Cl. F16K 11/044; B24B 55/06

(52) U.S. Cl. CPC F16K 11/044; B24B 55/06

(57) ABSTRACT

A pneumatic sander includes a suction device and a connection module. The connection module includes: an internal pipe having an air inlet connectable to a compressed-air source; a first air outlet supplying the sander with air via a first air passage; a second air outlet supplying the suction device with air via a second air passage; and a movable obturator mounted in the internal pipe. On start up, the air source delivers compressed air in the first air passage to force the obturator against a spring element to enable airflow to pass to the first air outlet and then to the sander, and at the same time to allow airflow to pass to a motor of the suction device, causing the suction device to suck dust from the sander. When the sander is stopped, the spring element forces the obturator towards an idle position to close the air passages.

### FIELD OF THE DISCLOSURE

The field of the disclosure is that of pneumatic suction, and in particular dust suction or extraction, devices.

Such suction devices may be used to suck in dust created by the operation of a tool, such as a pneumatic sander for example, for repairing car bodies.

### PRIOR ART

In the car body repair field, the sanding operation is combined with the use of a suction device to collect the sanding particles, in particular aluminium particles, also called hereinafter dust. When sucked in, the particles do not pollute ambient air in the garage and do not harm the health of the car-body mechanic.

For occasional uses or for areas that are hard to access, complete mobile sets are known composed of a suction unit (a wheeled suction device, for example) and an electric sander. In order to comply with the ATEX standard, the electrical portions of electrical sanders used in these mobile sets must be isolated from the outside and from the sucked dust in particular. Once stored, the aluminium dust can explode in the presence of a spark (from an electric motor, for example). Such insulation is relatively complex and expensive to implement. Thus, the cost of these sanders is very high, which forms a major obstacle to use thereof on a large scale. In addition, in car body workshops, the mobile sanding equipment is barely maintained. Hence, the fine particles clog the collection bag and any filters, which results in suction being quickly impaired. Furthermore, the weight of the electrical sander is relatively high, which affects its ergonomics.

Thus, in general, car-body mechanics use pneumatic sanders since these are light, handy and have no risk in the presence of aluminium particles. In general, pneumatic sanders are connected to a suction unit, itself connected to a compressed air network deployed in the premises of the car-body mechanic. Thus, both the pneumatic sander and the suction device are connected to the compressed air network of the premises of the car-body mechanic. A drawback of this solution lies in the fact that to obtain an optimum operation of the pneumatic sander and suction device, it is necessary to provide an air supply at a very high pressure, in the range of about 7 bar. In addition, this very high air consumption of the sander and of the suction device can generate disturbances throughout the entire compressed air network. In particular, this might cause air flow rate variations on the other tools of the facility and cause quality problems, for example in the case of a pneumatic painting station connected to this same network.

Devices for the automatic starting and stopping of the suction device have been proposed, depending on whether or not the sander is activated, so as to minimise such disturbances. The structure of these devices is however complex, and uses numerous components. Since the current solutions are not satisfactory, there is therefore a need for providing a new suction solution which allows obtaining an optimum operation of the suction device when it is used with a pneumatic sander (or any other pneumatic tool) on a compressed air supply network, without disturbing the latter.

### SUMMARY

The technique of an exemplary aspect of the present disclosure allows solving at least some of the drawbacks raised by the prior art.

An exemplary aspect of the disclosure relates to a pneumatic sander, in particular for a car body workshop, comprising a device for pneumatic suction of the sanding dust and a module for connecting the sander and the suction device to a compressed-air source, said connection module comprising:
an internal pipe having an air inlet connected to a compressed-air source,
a first air outlet supplying the sander with air (pilot supply) and disposed in communication with the air inlet through a first air passage,
a second air outlet supplying the sanding dust suction device with air and disposed in communication with the air inlet through a second air passage,
a movable obturator mounted in the internal pipe, said movable obturator being in the idle position when said sander is stopped, and forced by a spring element to at least partially close the first air passage and the second air passage,
   said connection module being configured to:
when the sander is started up, said compressed-air source delivers compressed air in said first air passage to force said movable obturator against said spring element so as to open the first air passage and to enable the compressed air to pass from the air inlet to the first air outlet and then to said sander, and at the same time to open the second air passage to allow the compressed air to pass to said motor of said suction device, causing said suction device to suck the dust from said sander;
when said sander is stopped, said spring element forces said movable obturator towards its idle position.

An exemplary aspect of the disclosure therefore proposes a simple, solely pneumatic, mechanism that makes it possible to start the suction when the sander is used.

In other words, the pneumatic extractor is designed to have an automatic start and stop mode depending on whether the sander is started or stopped. The main advantage is a reduction in the consumption of compressed air while keeping an optimum vacuum performance, and an excellent suction performance without using an electrical component part.

The disturbances generated on the general compressed air supply network of the workshop by the operation of the dust suction device are limited.

Thus, an exemplary aspect of the disclosure provides a suction solution particularly suited to dust, and in particular aluminium dust, suction. Furthermore, the pneumatic suction device according to an exemplary aspect of the disclosure is compliant with the ATEX standard, a standard that must in particular be complied with in car body workshops. The suction device according to an exemplary aspect of the disclosure therefore allows safe use in certain hazardous/critical environments.

Thus, an exemplary aspect of the disclosure suggests a new and inventive approach allowing solving the drawbacks of the prior art by providing a suction solution that is simple to implement offering high suction performances for optimum air consumption.

According to a particular aspect of the disclosure, said movable obturator comprises a first part closing off the second air passage towards the extractor when said sander is stopped, said first part being extended by a second part connected to the spring element and comprising a hemispherical-shaped element coming substantially in contact with an interior wall of the internal pipe to at least partially close the first air passage to the sander, the first air passage extending in an internal channel of the first part, so that, when the sander is started up, the airflow coming from the air inlet flows in the internal channel towards the concave face of the hemispherical-shaped element to move said hemispherical-shaped element of the movable obturator away from the interior wall of the internal pipe and to allow the airflow to pass firstly to the first air outlet communicating with the sander and secondly to the second air outlet communicating with the pneumatic extractor. Advantageously, the first part of the movable obturator comprises at least one orifice for the airflow to pass from the internal channel to the concave face of the hemispherical-shaped element.

Advantageously, the spring element connected to the second part of the movable obturator is secured to a wall of the internal pipe so as to force the movement of the movable obturator towards the air inlet and the second air outlet when the sander is not running. According to a particular aspect of the disclosure, a manual-manoeuvring member makes it possible to act on the movable obturator to move it in the internal pipe from its idle position to a position allowing the airflow to pass from the air inlet to the second air outlet communicating with the pneumatic extractor.

An exemplary aspect of the disclosure also relates to a connection module for a sander as described previously.

An exemplary aspect of the disclosure also relates to a plant comprising a general network for supplying compressed air comprising at least one sander as described previously.

### LIST OF THE FIGURES

One or more aspects of the present disclosure, as well as the different advantages thereof, will be understood more easily, in light of the following description of an illustrative and non-limiting embodiment thereof, and from the appended drawings wherein:

FIG. 1 is a view in cross section of a pneumatic connection module used in a sander according to the invention when the sander is not in operation;

FIG. 2 is a detail view of a portion of the module of FIG. 1;

FIG. 3 is a view in cross section of the module of FIG. 1 when the sander is in operation;

FIG. 4 is a view in cross section of the module of FIG. 1 showing schematically the manual activation of the module.

### DETAILED DESCRIPTION OF ILLUSTRATIVE EMBODIMENTS OF THE DISCLOSURE

An exemplary aspect of the present disclosure relates to a pneumatic sander, in particular for a car body workshop, comprising a device for pneumatic suction of the sanding dust and a module for connecting the sander and the suction device to a compressed-air source allowing the automatic stopping and starting of the suction device depending on whether the sander is activated (or in operation) or deactivated (stopped) respectively.

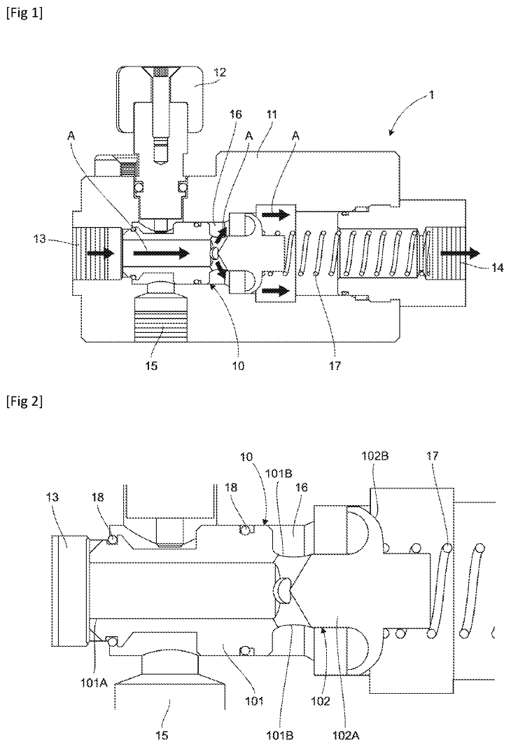

FIG. 1 is a view in cross section of the pneumatic connecting module 1 of such a pneumatic sander in the idle state, i.e. when the sander is not in operation.

The device for sucking sanding dust comprises a compressed-air motor and a container for collecting the sanding dust (neither shown). The sanding machine is actuated by a compressed-air motor and comprises one or more sanding members (not shown).

The connecting module 1 comprises a body 11, for example made of a metallic or plastic material. The body 11 can be machined/shaped, at a first end, to have an air inlet 13 intended to be connected to a compressed-air source. This source corresponds to the compressed-air network supplying the whole of the workshop, the air pressure at the inlet being for example of the order of 7 bar or less. The air inlet 13 takes the form of a cylindrical housing for connection with a compressed-air supply tube. The body 11 has, at a second end, opposite to the first end, a first air outlet 14 intended to supply air to a sander (“pilot supply”). This first air outlet 14 takes the form of a cylindrical housing for connection with a tube connected to the sander. An internal air pipe 16, rectilinear and cylindrical in shape, extends in the body 11 between the air inlet 13 and the first air outlet 14. A second air outlet 15 disposed in proximity to the air inlet 13 emerges in the internal air pipe 16 and is intended to supply air to the pneumatic extractor (“piloted supply”). This second air outlet takes the form of a cylindrical housing for connection with a tube connected to the pneumatic extractor.

A first air passage A is defined between the air inlet 13 and the first air outlet 14. A second air passage B is defined between the air inlet 13 and the second air outlet 15.

Thus the first air outlet 14 is disposed in communication with the air inlet 13 through the first air passage A, and the second air outlet 15 is disposed in communication with the air inlet 13 through the second air passage B.

A movable obturator 10 is mounted in the internal pipe 16, and is forced by a spring element 17 in the idle position (FIG. 1) to at least partially close the first air passage A and the second air passage B when the sander is not in operation.

The internal pipe 16 has a plurality of successive cylindrical portions with distinct cross sections.

As illustrated on FIG. 2, the movable obturator 10 comprises a first cylindrical part 101 with a variable cross-section closing off the second air passage to the extractor when the sander is stopped under the effect of the spring element 17. It can be seen on this FIG. 2 that, in this idle position, the airflow coming from the air inlet 13 cannot pass between the interior wall of the internal pipe 16 and the exterior wall of the first cylindrical part 101 of the movable obturator 10 towards the second air outlet 15. The bevelled end of the first part 101 is pressed against the wall of the air inlet 13 and carries a peripheral seal 18 that prevents the air from entering the internal pipe 16 towards the extractor.

The first part 101 of the movable obturator 10 is extended by a second part 102 connected to an end of the spring element 17 that extends along the longitudinal axis of the internal pipe 16, the other end of the spring element 17 being secured to an interior wall of the internal pipe 16 at the first air outlet 14 communicating with the extractor.

The first part of the obturator element carries, at the periphery of its other longitudinal end, a second circular seal providing the seal with the interior walls of the internal pipe 16.

The second part 102 of the movable obturator 10 comprises a cylindrical core 102A around which a hemispherical-shaped (or parachute-shaped) element 102B extends the peripheral edge of which comes substantially in contact with an interior wall of the internal pipe 16 to at least partially close the first air passage towards the sander. In this idle position of the movable obturator 10 (FIGS. 1 and 2), the diameter of the hemispherical element 102B is slightly less than the inside diameter of the internal pipe 16 allowing a slight passage of air towards the second air outlet 15 communicating with the sander. At rest, the airflow from the first air passage A is insufficient to oppose the force of the spring element 17 and to move the movable obturator.

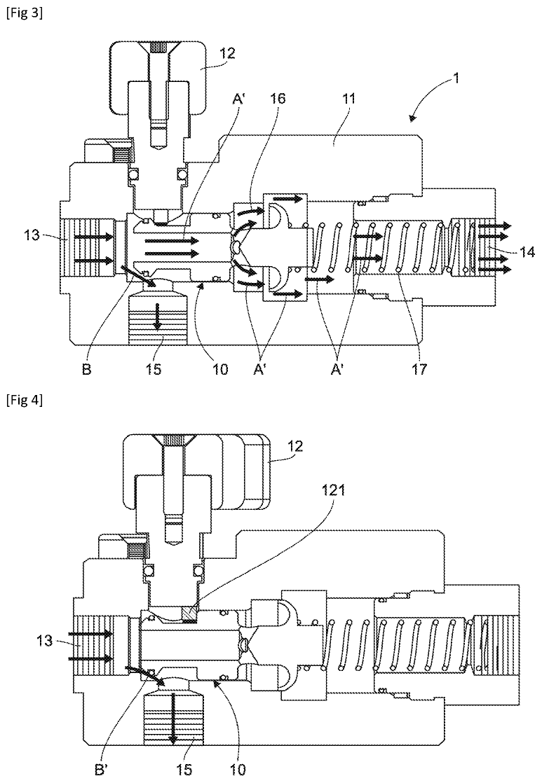

The first air passage A defined between the air inlet 13 and the first air outlet 14 extends first in a cylindrical internal channel 101A provided at the centre of the first part 101 of the movable obturator 10. When the sander is started up, the air inlet 13 that is connected to the general compressed-air supply network supplies a pressurised incoming airflow that flows in the internal channel 101A, and then in the internal pipe 16 by means of passage orifices 101B for the air (connecting the internal channel 101A to the internal pipe 16) that are provided at the interface between the first part 101 and the second part 102 of the movable obturator 10. These passage orifices 101B for the air emerge in the internal pipe 16 so that the incoming airflow is directed towards the concave face of the hemispherical element 102B. When the flow rate of the airflow in the first air passage is sufficiently great to oppose the force of the spring element 17, the airflow moves the hemispherical element 102B from left to right on the figures, and therefore the movable obturator 10, as far as the position illustrated on FIG. 3. In this position, the hemispherical element 102B is no longer in contact with the interior wall of the internal pipe 16 and the airflow coming from the passage orifices 101B can therefore bypass the movable obturator 10 to be directed towards the air outlet 14 communicating with the sander. The first air passage at this instant is referenced A′. At the same time, as can be seen on FIG. 3, the bevelled end of the first part 101 is no longer pressed against the wall of the air inlet 13 so that a part of the incoming airflow coming from the first air outlet 13 can go into the second air passage towards the second air outlet 15 communicating with the pneumatic extractor. In the position of the movable obturator 10 in FIG. 3, the incoming compressed air flow is directed firstly towards the sander via the first air passage A′ and secondly towards the motor of the pneumatic extractor via the second air passage B, the latter then being able to suck the dust from the sander.

Thus, when the sander is started up, the pneumatic extractor is also started up by means of a mechanism that is simple in design and solely mechanical.

It will be understood that, when the operation of the sander is interrupted (stoppage of the sander), the spring element 17 forming a return spring moves the movable obturator 10 towards the left, which at least partially re-closes the first air passage and re-closes the second air passage, so as to cut off the compressed-air supply to the motor of the pneumatic extractor. Consequently the pneumatic extractor switches off almost simultaneously. The movable obturator 10 therefore returns to the idle position. The airflows in the connection module 1 are illustrated schematically by arrows on FIGS. 1 to 3.

To recapitulate, FIG. 1 illustrates the connection module in the idle state of the movable obturator 10.

The air inlet or outlet 13 is connected to the compressed-air network (under pressure). The sander being non-active, the pressure is distributed throughout the system. There is a clearance between the movable obturator 10 and the interior wall of the internal pipe 16 that allows the air to pass (first air passage A). Under the effect of the spring element 17, the movable obturator 10 forming a slide closes the second passage of the air towards the pneumatic extractor.

When the sander is started up, the compressed-air source delivers compressed air in said first air passage to force the movable obturator 10 against the spring element 17 so as to further open the first air passage A′ and to enable the compressed air to pass from the air inlet 13 to the first air outlet 14 and then to the sander, and at the same time to open the second air passage B to allow the compressed air to pass to the motor of the pneumatic extractor, causing the pneumatic extractor to suck the dust from the sander. FIG. 3 illustrates the automatic actuation of the extractor when the sander is actuated. In this case, the sander consumes compressed air (increasing the air flow rate). The air coming from the air inlet 13 takes the first air passage A and thus flows in the internal channel 101A and passes into the internal pipe 16 by means of the passage orifices 101B for the air connecting the internal channel 101A to the internal pipe 16. When the flow rate of air is sufficient to oppose the force of the spring element 17 and to move the movable obturator 102B, the movable obturator 10 moves towards the right (i.e. towards the first air outlet 14). The diameter of the hemispherical element is less than the inside diameter of the internal pipe so that the compressed-airflow passes with a higher flow rate to the first outlet 14 communicating with the sander. Furthermore, the second air passage B is no longer closed off by the movable obturator 10 and the incoming airflow can also pass from the air inlet 13 to the second air outlet 15.

FIG. 4 illustrates the manual opening of the second air passage towards the extractor. To do this, the connection module 1 is equipped with a handle, or manual manoeuvring member, 12. Through rotation of the handle 12, a cam 121 moves the movable obturator 10 towards the right, away from the air inlet 13. Because of this the compressed-air flow coming from the air inlet 13 can pass towards the second air outlet 15 via the second air passage B′.

Means (a screw for example) for adjusting the force of the spring element 17 forming a return spring can be provided.

The spring element may be a spiral spring or any other type of spring, or a mechanical part manufactured from a specific material.

Although the present disclosure has been described with reference to one or more examples, workers skilled in the art will recognize that changes may be made in form and detail without departing from the scope of the disclosure and/or the appended claims.

1. A pneumatic sander comprising:
a suction device for pneumatic suction of sanding dust; and
a connection module for connecting the sander and the suction device to a compressed-air source, said connection module comprising:
an internal pipe having an air inlet connectable to a compressed-air source,
a first air outlet to supply the sander with air and disposed in communication with the air inlet through a first air passage,
a second air outlet to supply the sanding dust suction device with air and disposed in communication with the air inlet through a second air passage,
a spring element, and
a movable obturator which is mounted in the internal pipe and is movable between:
an idle position when said sander is in a stopped state, and in which the obturator is forced by the spring element to at least partially close the first air passage and the second air passage, and
an open position when the sander is in a run state, and in which said movable obturator is forced against said spring element so as to open the first air passage and to enable airflow to pass from the air inlet to the first air outlet and then to said sander, and at the same time to open the second air passage to allow the airflow to pass to a the second air outlet and then to a motor of said suction device, causing said suction device to suck the dust from said sander, the obturator being movable into the open position by compressed air received through the air inlet.

2. The pneumatic sander according to claim 1, wherein said movable obturator comprises:
a first part closing off the second air passage to the extractor when said sander is in the stopped state, said first part being extended by a second part connected to the spring element and comprising a hemispherical-shaped element coming substantially in contact with an interior wall of the internal pipe to at least partially close the first air passage towards the sander,
the first air passage extending in an internal channel of the first part, so that, when the sander is in the run state, airflow coming from the air inlet flows in the internal channel towards a concave face of the hemispherical-shaped element to move said hemispherical-shaped element of the movable obturator away from the interior wall of the internal pipe and to allow the airflow to pass firstly towards the first air outlet communicating with the sander and secondly towards the second air outlet communicating with the pneumatic extractor.

3. The pneumatic sander according to claim 2, wherein the first part of the movable obturator comprises at least one orifice for airflow to pass from the internal channel to the concave face of the hemispherical-shaped element.

4. The pneumatic sander according to claim 2, wherein the spring element connected to the second part of the movable obturator is secured to a wall of the internal pipe so as to force movement of the movable obturator towards the air inlet and the second air outlet when the sander is in the stopped state.

5. The pneumatic sander according to claim 1, comprising a manual-maneuvering member which acts on the movable obturator to move the moveable obturator in the internal pipe from its idle position to the open position, allowing airflow to pass from the air inlet to the second air outlet communicating with the suction device.

6. A connection module for a pneumatic sander, the connection module comprising:
an internal pipe having an air inlet connectable to a compressed-air source,
a first air outlet connectable to supply the sander with air and disposed in communication with the air inlet through a first air passage;
a second air outlet connectable to supply a sanding dust suction device with air and disposed in communication with the air inlet through a second air passage;
a spring element; and
a movable obturator which is mounted in the internal pipe and is movable between:
an idle position in which the obturator is forced by the spring element to at least partially close the first air passage and the second air passage, and
an open position in which said movable obturator is forced against said spring element so as to open the first air passage and to enable airflow to pass from the air inlet to the first air outlet, and at the same time to open the second air passage to allow the airflow to pass to the second air outlet, the obturator being movable to the open position by compressed air received through the air inlet.

7. A plant comprising:
a general network for supplying compressed air, including the compressed-air source; and
at least one sander according to claim 1 connected to the general network.
